(19) United States
(12) Patent Application Publication
(10) Pub. No.: US 2007/0291053 A1
(43) Pub. Date: Dec. 20, 2007

(54) Image display device and image display method

(76) Inventors: Shingo Kida, Kanagawa-ken (JP); Masahiro Kitaura, Kanagawa-ken (JP)

Correspondence Address: THE NATH LAW GROUP, 112 S. West St., Alexandria, VA, 22314, US

(21) Appl. No.: 11/812,080

(22) Filed: Jun. 14, 2007

(30) Foreign Application Priority Data
Jun. 15, 2006 (JP) P2006-166699
May 9, 2007 (JP) P2007-124432

(51) Int. Cl. G09G 5/10

(52) U.S. Cl. 345/690

(57) ABSTRACT

An image display device comprises the following five units. A histogram generating unit generates histogram data based on an image signal. An amount-of-light control unit controls an amount-of-light adjustment unit so that the amount of light decreases as a ratio corresponding to a black color increase based on the histogram data. A holding unit holds first gradient correction data which is used to decide a character of an output gradient with respect to an input gradient of the image signal. An additional data generating unit generates additional data including one or more values which each increases as the ratio increases and adds the one or more values into the first gradient correction data in order to increase one or more gradients in a middle gradient region of the image signal.

### BACKGROUND OF THE INVENTION

1. Field of the Invention

The present invention relates to an image display device and an image display method for controlling an amount of light emitted from a light source according to an image signal, more specifically, to an image display device and an image display method for correcting an image signal in association with the control of the amount of light.

2. Description of the Related Art

Recently, there is a projection display device, a liquid crystal display device (LCD) or a plasma display device (PDP) as an image display device, instead of a conventional cathode-ray tube display device (CRT). The projection display device needs a light source which is employed to cause light to enter a light modulation element. The liquid crystal display device also needs a light source as a backlight. For example, an image display device provided with a light source is disclosed in Japanese Patent Laid-open Publication No. 2003-36063.

However, it is difficult to display a real black color on the projection display device or the liquid crystal display device because a part of light emitted from the light source illuminates a dark displayed image to increase luminance of the dark displayed image.

### SUMMARY OF THE INVENTION

The present invention has an object to provide an image display device and an image display method capable of reproducing a substantially real black color of an image to be displayed on the image display device to give a contrasty image to a user even if the image display device is provided with a light source.

In order to achieve the above object, the present invention provides the following (A) to (H):

(A) an image display device comprising: a display unit (7, 8) configured to display an image signal thereon; a light source (71, 86) configured to emit light to be used to display the image signal on the display unit; an amount-of-light adjustment unit (72, 82) configured to adjust an amount of light emitted from the light source; a histogram generating unit (21) configured to normalize each luminance value of a luminance signal component of the image signal in the range of a minimum luminance value to a maximum luminance value of the luminance signal component by a predetermined time to generate plural gradients of the luminance signal component and generate histogram data which shows a distribution of frequencies of the plural gradients; a holding unit (31) configured to hold first gradient correction data which is used to decide a character of an output gradient with respect to an input gradient of the image signal; an amount-of-light control unit (3, 79, 82) configured to control the amount-of -light adjustment unit on the basis of the histogram data so that the amount of light emitted from the light source decreases as a ratio of total frequencies of one or more gradients corresponding to a black color to total frequencies of the plural gradients increases by the predetermined time; an additional data generating unit (31) configured to generate additional data including one or more values which each increases as the ratio of the total frequencies of the one or more gradients corresponding to the black color to the total frequencies of the plural gradients increases by the predetermined time, wherein the additional data is used to add the one or more values into the first gradient correction data in order to increase one or more gradients in a middle gradient region of the image signal; and a gradient correction unit (42) configured to correct one or more gradients of the image signal on the basis of either one of the first gradient correction data and second gradient correction data generated by adding the additional data into the first gradient correction data;

(B) the image display device according to (A), further comprising; an enhancement processing unit (41, 410) configured to carry out an edge reinforcement of the image signal; and a control unit (3) configured to control the enhancement processing unit on the basis of the histogram data so that the edge reinforcement is promoted as the ratio of the total frequencies of the one or more gradients corresponding to the black color to the total frequencies of the plural gradients increases by the predetermined time;

(C) the image display device according to (B), wherein the enhancement processing unit (410) inputs the image signal of which the edge reinforcement has been carried out into the gradient correction unit and the histogram generating unit;

(D) the image display device according to (A), wherein the additional data generating unit generates the additional data so that a difference between adjacent gradients in a gradient region including the middle gradient region is equal to or less than a predetermined value;

(E) the image display device according to (A), wherein further comprising: a light modulation element (74) configured to modulate light entering the light modulation element on the basis of the image signal; a white balance correction unit (78) configured to correct a white balance of the image signal and input the corrected image signal into the light modulation element; and a white balance control unit (3) configured to control a correction of the white balance in the white balance correction unit according to the amount of light passing through the amount-of-light adjustment unit, wherein the light source emits the light which is to enter the light modulation element and the amount-of-light adjustment unit is an iris (72) configured to adjust the amount of light emitted from the light source;

(F) the image display device according to (A), wherein the display unit has a liquid crystal panel (85) and the light source is a backlight (86) configured to emit light which is to enter the liquid crystal panel;

(G) An image display method comprising the steps of: normalizing each luminance value of a luminance signal component of an image signal to be displayed on a display unit in the range of plural gradients by a predetermined time and generating histogram data which shows a distribution of frequencies of the plural gradients; calculating a ratio of total frequencies of one or more gradients corresponding to a black color to total frequencies of the plural gradients by the predetermined time on the basis of the histogram data; decreasing an amount of light to be emitted from a light source and used to display the image signal on the display unit as the ratio of the total frequencies of the one or more gradients corresponding to the black color to the total frequencies of the plural gradients increases; and increasing one or more gradients in a middle gradient region of the image signal as the amount of light emitted from the light source decreases; and

(H) the image display method according to (G), further comprising a step of promoting an edge reinforcement of the image signal as the amount of light emitted from the light source decreases.

According to the present invention, the image display device and the image display method can reproduce a substantially real black color of an image to be displayed to give a contrasty image to a user, while the displayed image keeps the brightness in a white side.

### BRIEF DESCRIPTION OF THE DRAWINGS

FIG. 1 is a block diagram of an image display device according to a first exemplary embodiment of the present invention.

FIG. 2 is a block diagram of a display unit according to the first exemplary embodiment of the present invention.

FIG. 3A is an explanatory diagram of a fully open condition of an iris according to the first exemplary embodiment of the present invention.

FIG. 3B is an explanatory diagram of a partly close condition of the iris according to the first exemplary embodiment of the present invention.

FIG. 4 is a diagram showing a luminance distribution of a luminance signal component of an input image signal according to the first exemplary embodiment of the present invention.

FIG. 5 is a diagram to which the image display device refers at a time of carrying out an adjustment of an amount of light according to the first exemplary embodiment of the present invention.

FIG. 6 is a diagram to which the image display device refers at a time of carrying out an enhancement process according to the first exemplary embodiment of the present invention.

FIG. 7A is the same diagram as FIG. 4,

FIG. 7B is a diagram showing an offset value distribution after the image display device carries out a dynamic gamma process according to the first exemplary embodiment of the present invention.

FIG. 8A is the same diagram as FIG. 7B.

FIG. 8B is a diagram showing an offset value distribution after the image display device carries out a difference limiter process according to the first exemplary embodiment of the present invention.

FIG. 9 is a diagram showing two corrected gamma curves according to the first exemplary embodiment of the present invention.

FIG. 10 is a table showing opening ratios of the iris and transmittances of amounts of light L R (red), light LG (green) and light LB (blue) according to the first exemplary embodiment of the present invention.

FIG. 11 is a diagram showing a corrected drive value of an R signal according to the first exemplary embodiment of the present invention.

FIG. 12 is a diagram showing a corrected drive value of a G signal according to the first exemplary embodiment of the present invention.

FIG. 13A is a circuit diagram of an IIR filter according to the first exemplary embodiment of the present invention.

FIG. 13B is a diagram showing a character of the IIR filter according to the first exemplary embodiment of the present invention.

FIG. 14 is a block diagram of an image display device according to a second exemplary embodiment of the present invention.

FIG. 15 is a block diagram of an image display device according to a third exemplary embodiment of the present invention.

FIG. 16 is a diagram to which the image display device refers at a time of carrying out an adjustment of an amount of light according to the third exemplary embodiment of the present invention.

### DESCRIPTION OF THE PREFERRED EMBODIMENTS

### First Exemplary Embodiment

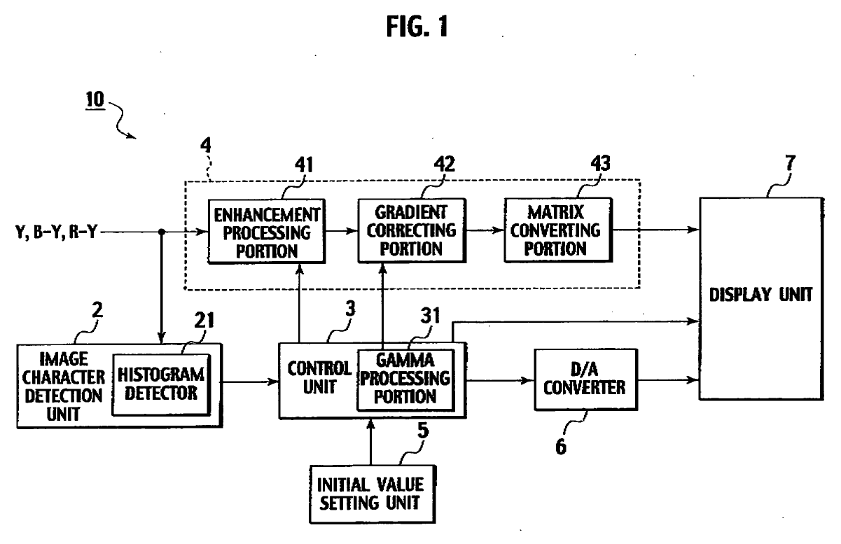

An image display device 10 according to a first exemplary embodiment of the present invention will be described below in detail, with reference to FIGS. 1 to 13B.

The image display device 10 is a projection display device. The image display device 10 comprises an image character detection unit 2, a control unit 3, an image signal processing unit 4, an initial value setting unit 5, a digital-to-analog (D/A) converter 6 and a display unit 7.

An input image signal includes a luminance signal component Y and color difference signal components B-Y, R-Y and is firstly input into the image character detection unit 2 and the image signal processing unit 4. The input image signal is an interlaced signal to be input by one field or a progressive signal to be input by one frame. In the first exemplary embodiment, the progressive signal is input into the image character detection unit 2 and the image signal processing unit 4 by one frame, as the input image signal.

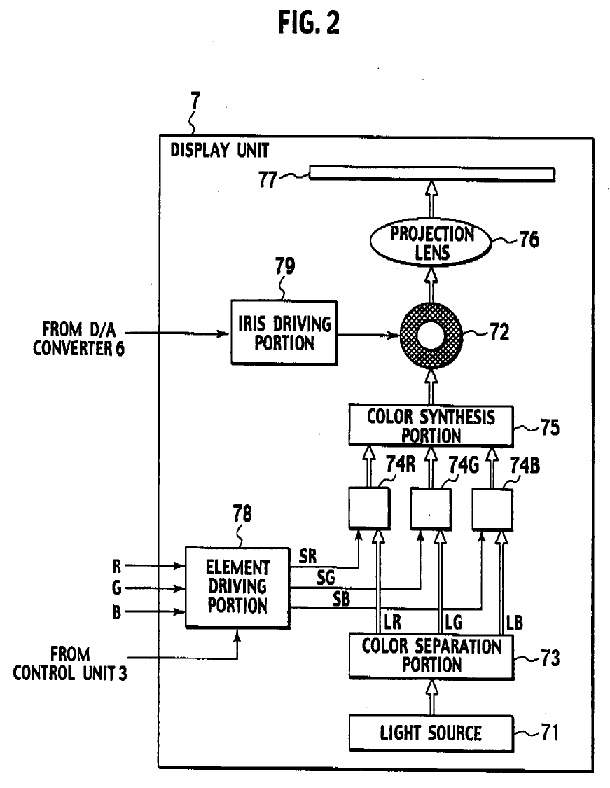

The image character detection unit 2 generates data (detection signal) representing an image character from the input image signal by one frame and outputs the detection signal into the control unit 3. It is noted that the image character detection unit 2 may generate a detection signal on the basis of one or more pixels included in a predetermined area of a screen 77 (see FIG. 2) which has a center area of the screen 77, instead of generating the detection signal from the input image signal by one frame.

The image character detection unit 2 has a histogram detector 21 and outputs the data representing a histogram (the image character by one frame) into the control unit 3 as the detection signal. More specifically, the histogram detector 21 normalizes each luminance value of the luminance signal component Y of the input image signal in the range of a minimum luminance value to a maximum luminance value of the luminance signal component Y by a predetermined time (that is, by one frame) to generate each gradient of the luminance signal component Y. Then, the histogram detector 21 counts the number of pixels belonging to each gradient and then generates histogram data representing a gradient distribution.

The control unit 3 generates first control data to be used to control the image signal processing unit 4, on the basis of the detection signal (the histogram data) output from the image character detection unit 2. The control unit 3 also generates second control data to be used to control an amount of light to be emitted from a light source 71 (see FIG. 2) mounted in the display unit 7, on the basis of an Initial setting value output from the initial value setting unit 5 and the detection signal output from the image character detection unit 2. The control unit 3 includes a central processing unit (CPU) therein and controls the whole of the image display device 10.

The image signal processing unit 4 has an enhancement processing portion 41, a gradient correcting portion 42 and a matrix converting portion 43. The image signal processing unit 4 corrects the input image signal on the basis of the first control data and second gradient correcting data, which will be described later, generated in the control unit 3 and outputs the corrected input image signal into the display unit 7 as an output image signal. The correction of the input image signal to be carried out in the image signal processing unit 4 is linked with the control of the amount of light to be carried out in the display unit 7.

The enhancement processing portion 41 carries out an enhancement process for the input image signal. The gradient correcting portion 42 carries out a gradient correction. The corrected input image signal is input into the matrix converting portion 43 and converted into the output image signal regarding R (red), G (green) and B (blue). The matrix converting portion 43 outputs the output image signal into the display unit 7.

The initial value setting unit 5 holds the initial setting value to be used to set the amount of light to be emitted from the light source 71. For example, the initial setting value is a current value. The initial setting value is set before shipment of the image display device 10 or by a user's manual operation.

The D/A converter 6 converts the second control data into an analog signal and outputs the analog signal into the display unit 7. In the display unit 7, the control of the amount of light based on the second control data is linked with a display based on the output image signal output from the image signal processing unit 4.

As shown in FIG. 2, the display unit 7 has the light source (lamp) 71, a mechanical iris 72, a color separation portion 73, light modulation elements 74R, 74G, 74B, a color synthesis portion 75, a projection lens 76, the screen 77, an element driving portion 78 and an iris driving portion 79.

The light source 71 emits light which is used to display the output image signal on the screen 77. The light emitted from the light source 71 enters the color separation portion 73. The color separation portion 73 separates the light into light LR including a color R (red) component, light LG including a color G (green) component and light LB including a color B (blue) component and outputs the light LR, the light LG and the light LB into the light modulation elements 74R, 74G, 74B, respectively.

The element driving portion 78 corrects the output image signal regarding R (red), G (green) and B (blue) output from the matrix converting portion 43 on the basis of third control data output from the control unit 3 and then outputs corrected image signals SR, SG, SB into the light modulation elements 74R, 74G, 74B, respectively. The light modulation elements 74R, 74G, 74B modulate the light LR, the light LG and the light LB into light LRm, light LGm and light LBm on the basis of the corrected image signals SR, SG, SB, respectively. Then, the light modulation elements 74R, 74G, 74B output the light LRm, the light LGm and the light LBm into the color synthesis portion 75, respectively.

The color synthesis portion 75 synthesizes the light LRm, the light LGm and the light LBm to generate the synthesized light. Then, the color synthesis portion 75 outputs the synthesized light into the projection lens 76 through the iris 72. The projection lens 76 projects the synthesized light onto the screen 77. The iris 72 adjusts an amount of the synthesized light which will enter the projection lens 76. It is noted that the iris 72 may be located in any position between the light source 71 and the projection lens 76, instead of the position shown in FIG. 2.

The color separation portion 73 is composed of two dichroic mirrors and a plurality of reflecting mirrors. The color synthesis portion 75 is composed of one or more reflecting mirrors or one or more synthesis prisms.

The image character detection unit 2 and the image signal processing unit 4 are generally realized by hardware with high speed processing because these units carry out simple information processing by one pixel. In contrast, the control unit 3 is generally realized by software using a CPU because this unit executes an image analysis by carrying out complex calculation processing by one frame.

(Adjustment of the Amount of Light by the Iris 72)

The amount of light is adjusted by opening or closing the iris 72. The iris driving portion 79 controls the opening or closing of the iris 72. More specifically, the iris driving portion 79 controls the iris 72 according to the second control data (iris control data) generated in the control unit 3.

In the first exemplary embodiment, the control unit 3 generates the second control data to be used to control the opening or closing of the iris 72, on the basis of the detection signal output from the image character detection unit 2, as follows.

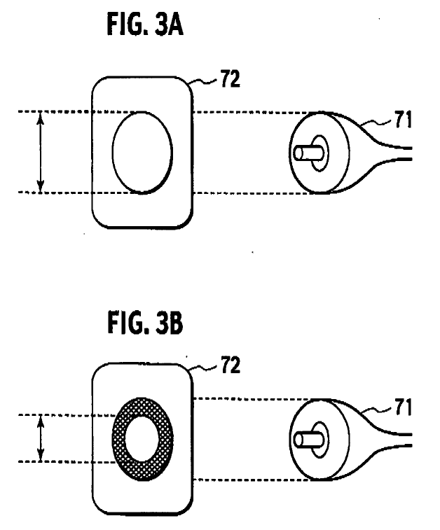

As shown in FIG. 3A, a fully open condition of the iris 72 allows all light emitted from the light source 71 to pass through the iris 72. As shown in FIG. 3B, a partly close condition of the iris 72 allows a part of light emitted from the light source 71 to pass through the iris 72. It is noted that the amount of light emitted from the light source 71 is drawn in dotted lines and the configurations between the light source 71 and the iris 72 are omitted, in FIGS. 3A and 3B.

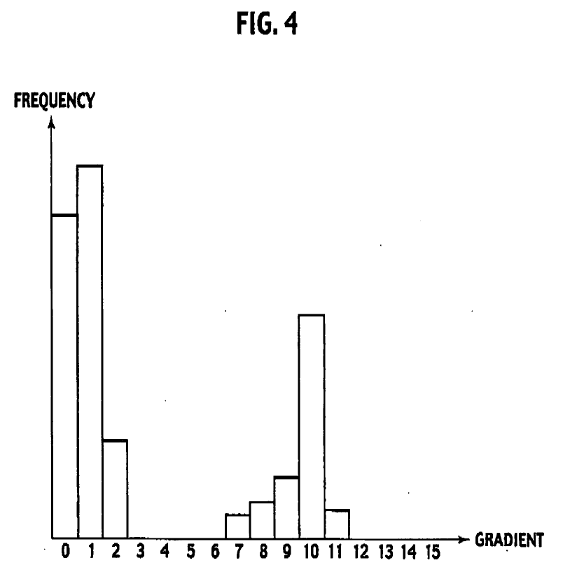

The detection signal is the histogram data. The histogram detector 21 normalizes each luminance value of the luminance signal component Y of the input image signal in the range of 0 to 255 gradients. The normalized luminance value is represented by 8 bits. Then, the histogram detector 21 generates 16 pieces of histogram data H(i) (0≦i≦15) by using high 4 bits of the normalized luminance value. FIG. 4 shows a histogram of the input image signal generated by capturing an image in a condition where there is a person under a starry sky.

It is noted that horizontal and vertical axes of FIG. 4 show the gradient i (0≦i≦15) and a frequency of the histogram data H(i) of the luminance signal component Y, respectively. In the condition where there is a person under a starry sky, the frequencies of 2 pieces of histogram data H(0) and H(1) (a black side) are generally higher than those of other 14 pieces of histogram data, and a spike shape is generally formed around histogram data H(10) in a middle gradient region.

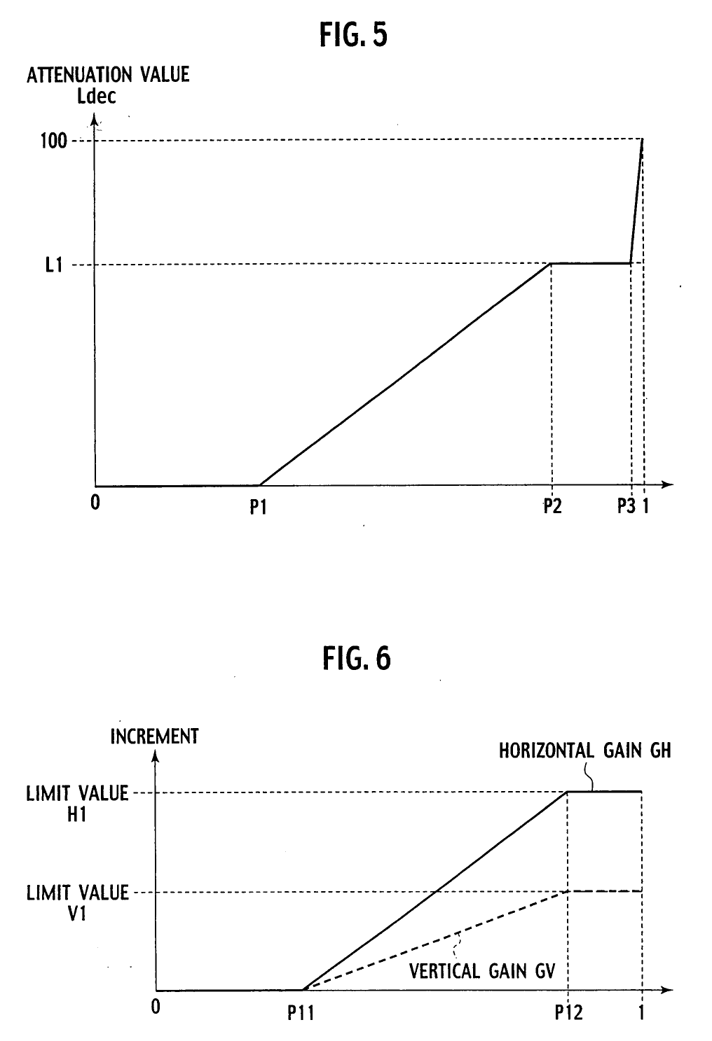

The control unit 3 calculates an attenuation value Ldec of the amount of light emitted from the light source 71 on the basis of the detection signal, with reference to an attenuation value line shown in FIG. 5. It is noted that horizontal and vertical axes of FIG. 5 show a ratio (black information) of a total frequencies of 2 pieces of histogram data H(0) and H(1) to a total frequencies of all 16 pieces of histogram data and the attenuation value Ldec, respectively. In the first exemplary embodiment, we consider gradients 0 and 1 as gradients corresponding to a black color.

The attenuation value Ldec shows a ratio of an amount of light which is emitted from the light source 71 and does not pass through the iris 72, to an amount of light which is emitted from the light source 71. In a case where the attenuation value Ldec is 0%, the amount of light passing through the iris 72 is equal to that emitted from the light source 71 because the iris 72 has a fully open condition. In a case where the attenuation value Ldec is 100%, the amount of light passing through the iris 72 is equal to 0 because the iris 72 has a fully close condition.

In the first exemplary embodiment, as shown in FIG. 5, the attenuation value Ldec is 0% between 2 pieces of black information 0 and P1 (control start point). The attenuation value Ldec linearly increases from 0% to L1% between 2 pieces of black information P1 and P2. The attenuation value Ldec is L1% between 2 pieces of black information P2 and P3. The attenuation value Ldec linearly increases from L1% to 100% between 2 pieces of black information P3 to 1. Namely, the amount of light passing through the iris 72 decreases as the value of black information increases.

The control unit 3 calculates the black information by a predetermined time (that is, by one frame) on the basis of the detection signal output from the image character detection unit 2, and then calculates the attenuation value Ldec regarding the calculated black information. It is noted that the black information 1 shows that one frame by which the input image signal is input into the image character detection unit 2 is a frame all blacked. 3 pieces of black information P1, P2, P3 and the attenuation value Ldec L1% are arbitrarily set. The control unit 3 further prevents the attenuation value Ldec from varying discontinuously in a time based process as will be described later.

The control unit 3 furthermore generates iris control data (the second control data), with reference to the calculated attenuation value Ldec and the initial setting value previously held in the initial value setting unit 5. It is noted that the initial setting value is a current value to be used to control an open condition of the iris 72 so as to maximize the amount of light passing through the iris 72. Namely, the initial setting value is a current value at a time when the attenuation value Ldec is 0.

The iris control data is input into the D/A converter 6, converted into an analog signal and output into the iris driving portion 79. The iris driving portion 79 drives the iris 72 on the basis of the iris control data which is the analog signal. An assembly of the control unit 3 and the iris driving portion 79 corresponds to an amount-of-light control unit configured to control the iris 72 (an amount-of-light adjustment unit).

The iris control data is data to be used to control the iris 72 so that the amount of light passing through the iris 72 decreases as the attenuation value Ldec increases. The iris control data has a value to maximize an open condition of the iris 72 at a time when the attenuation value Ldec is 0% and a value to minimize the open condition of the iris 72 at a time when the attenuation value Ldec is 100%.

As shown in FIG. 5, the image display device 10 prevents a part of light emitted from the light source 71 from illuminating a dark displayed image because the attenuation value Ldec is set so that the amount of light passing through the iris 72 decreases (that is, the amount of light which will enter the projection lens 76 decreases) as a ratio of gradients in the black color side increases.

(Input Image Signal Process Linked with the Adjustment of the Amount of Light)

In a case where the input image signal represents a scene that there is a person under a starry sky, if the amount of light which will enter the projection lens 76 is decreased only by the above-described adjustment, the problems are caused as follows: (1) a twinkling of a star is lost; and (2) a person's face is lost to sight. Accordingly, the image display device 10 needs to correct a part of the luminance signal component Y which represents a middle gradient or a high gradient (a middle gradient region) corresponding to a star and face, in association with the above-described adjustment.

In order to correct the part of the luminance signal component Y which represents the middle gradient or the high gradient, the image display device 10 carries out (1) an enhancement process (edge reinforcement process), (2) a dynamic gamma process, (3) a white balance correction process and (4) a time based process. We will describe these processes below as considering that the input image signal represents a scene that there is a person under a starry sky.

(1. Enhancement Process)

The enhancement process is a process for reinforcing an edge of image in an image signal. In the enhancement process, a chute component is generally added into the input image signal. The reinforcement of the edge of image Is carried out by adjusting a gain of the chute component.

In the first exemplary embodiment, the enhancement process is carried out in the enhancement processing portion 41. A configuration of the enhancement processing portion 41 is omitted because it is well known.

The control unit 3 generates enhancement data (the first control data) from the detection signal input from the image character detection unit 2 with reference to FIG. 6. The enhancement process portion 41 carries out the enhancement process with respect to the input image signal on the basis of the enhancement data input from the control unit 3.

Horizontal and vertical axes of FIG. 6 show the ratio (black information) of the total frequencies of 2 pieces of histogram data H(0) and H(1) to the total frequencies of all 16 pieces of histogram data and an increment of a horizontal gain GH or a vertical gain GV of the chute component, respectively. The control unit 3 generates the enhancement data in which the horizontal gain GH and the vertical gain GV increase as the ratio of the total frequencies of 2 pieces of histogram data H(0) and H(1) to the total frequencies of all 16 pieces of histogram data increases.

In the first exemplary embodiment, as shown in FIG. 6, the increment of the horizontal gain GH is 0 between 2 pieces of black information 0 and P11 (control start point). The increment of the horizontal gain GH linearly increases from 0 to H1 (limit value) between 2 pieces of black information P11 and P12. The increment of the horizontal gain GH is H1 between 2 pieces of black information P12 and 1. Namely, the control unit 3 generates the enhancement data in which the horizontal gain GH is not added between 2 pieces of black information 0 and P11 and is added between 2 pieces of black information P11 and 1. Further, in the enhancement data, the horizontal gain GH which is the limit value H1 is added between 2 pieces of black information P12 and 1.

Similarly, as shown in FIG. 6, the increment of the vertical gain GV is 0 between 2 pieces of black information 0 and P11. The increment of the vertical gain GV linearly increases from 0 to V1 (limit value) between 2 pieces of black information P11 and P12. The increment of the vertical gain GV is V1 between 2 pieces of black information P12 and 1. 2 pieces of black information P11, P12 and the limit values H1, V1 are arbitrarily set. It is preferable that the limit value V1 is smaller than the limit value H1. Change points corresponding to 2 pieces of black information P11 and P12 at which the increments of the horizontal gain GH and the vertical gain GV are changed may have different values each other. The control unit 3 further prevents the increments of the horizontal gain GH and the vertical gain GV from varying discontinuously in the time based process as will be described later.

It is noted that the limit value V1 is smaller than the limit value H1 because a visual influence by a vertical enhancement process with respect to an image is larger than one by a horizontal enhancement process. Accordingly, the enhancement process can emphasize stars which are dotted in a night sky to provide brightly shining stars to a viewer, even if the amount of light is decreased. Further, the enhancement process has least influence on objects other than the stars.

(2. Dynamic Gamma Process)

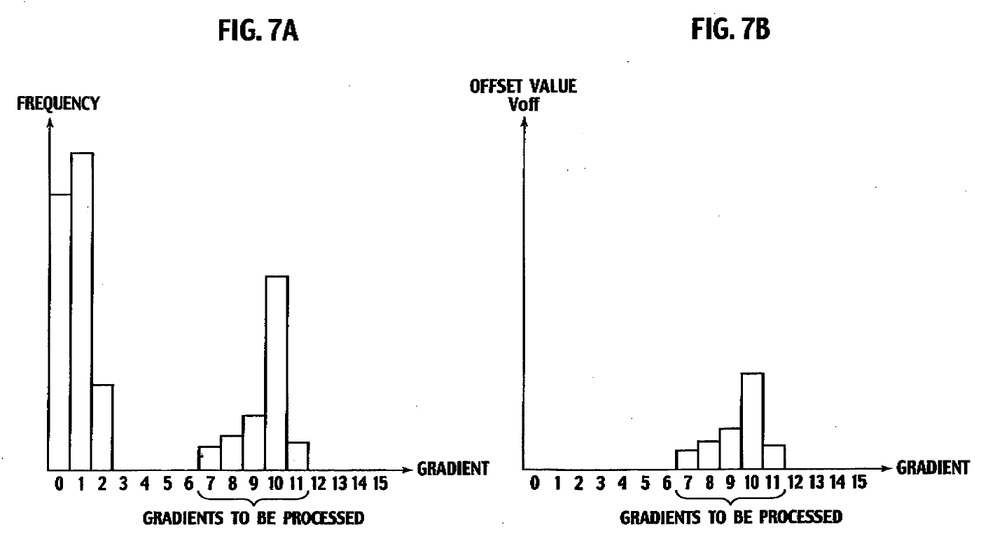

FIG. 7A is the same diagram as FIG. 4. Regarding the luminance signal component Y of the input image signal, the frequencies of 8 pieces of histogram data have values at the gradients 0 to 2 (dark side) and 7 to 11 (light side). Gradients of images of stars and a person's face are equal to the gradients 7 to 11. In a case where the luminance signal component Y has an image character in which a ratio of the total frequencies of the gradients 0 and 1 to the total frequencies of all gradients 0 to 15 has a large value as shown in FIG. 7A, if the adjustment of the amount of light by the iris 72 is only carried out, the amount of light corresponding to the output image signal is decreased, thereby a relative amount of light corresponding to the gradients 7 to 11 is also decreased to cause images corresponding to the gradients 7 to 11 to be darkened. In order to resolve the above-described problem, the image character detection unit 4 carries out the dynamic gamma process for increasing the gradients 7 to 11 with respect to the input image signal.

More specifically, the gradient correcting portion 42 carries out the dynamic gamma process. A gamma processing portion 31 previously holds first gradient correcting data which is used to decide a character of an output gradient with respect to an input gradient of the input image signal. The gamma processing portion 31 is a holding unit configured to hold gradient correcting data. If the first gradient correcting data is only used in a series of processes, the relative amount of light corresponding to the gradients 7 to 11 decreases to cause the images corresponding to the gradients 7 to 11 to be darkened, as the ratio of the total frequencies of the gradients 0 and 1 to the total frequencies of all gradients 0 to 15 increases. Accordingly, it is need to increase gradients in the middle gradient region.

In order to increase the gradients in the middle gradient region, the gamma processing portion 31 calculates offset values Voff with respect to these gradients, as will be described later, to generate offset data (additional data) showing the offset values Voff. The gamma processing portion 31 is an additional data generating unit. The offset data is generated by each gradient in the middle gradient region. The gamma processing portion 31 adds the offset data to the first gradient correcting data in the middle gradient region to generate second gradient correcting data. Then, the second gradient correcting data are input into the gradient correcting portion 42. The gradient correcting portion 42 corrects each gradient included in the luminance signal component Y of the input image signal, on the basis of the second gradient correcting data.

In the gamma processing portion 31, an offset value Voff of a desired gradient i is calculated as follows:
Voff=Ldec*Hrat*G (1)
where Ldec is the attenuation value, Hrat is a ratio of the frequency of histogram data H(i) to the total frequencies of all 16 pieces of histogram data and G is an offset gain. The offset gain G is arbitrarily set and used in a scale adjustment. The attenuation value Ldec which is previously calculated by the control unit 3 is used.

The offset value Voff is linked to the attenuation value Ldec. The offset value Voff increases as the attenuation value Ldec increases. Thus, the offset value Voff increases as the ratio of the total frequencies of 2 pieces of histogram data H(0) and H(1) to the total frequencies of all 16 pieces of histogram data increases. Also, the offset value Voff increases as the ratio Hrat increases because the offset value Voff is linked to the ratio Hrat.

The gamma processing portion 31 is the additional data generating unit configured to generate the additional data including the offset values Voff each which increases as the ratio of the total frequencies of 2 pieces of histogram data H(0) and H(1) to the total frequencies of all 16 pieces of histogram data increases per a certain unit time, on the basis of 16 pieces of histogram data input from the image character detection unit 2.

Horizontal and vertical axes of FIG. 7B show the gradient i (0≦i≦15) and the offset value Voff to be added to the first gradient correcting data. In the first exemplary embodiment, the gamma processing portion 31 calculates the offset values Voff to be added to the first gradient correcting data corresponding to the gradients 7 to 11. It is noted that a gradient region in which the offset values Voff are added to the first gradient correcting data is selected so as to visually improve image quality as the gradient region. It is preferable to select the middle gradient region. The selected gradient region is previously set in the gamma processing portion 31.

In the calculation of each offset value Voff in a certain gradient region according to the equation (1), if the frequency of histogram data [i] (0≦i≦15) is remarkably higher than the total frequencies of other pieces of histogram data, the Hrat has a large value. In this case, the offset value Voff to be added to the first gradient correcting data regarding the gradient i also has a large value. Thus, a contrast difference is visually emphasized because the gradient i is remarkably increased by the second correcting data.

In order to prevent the emphasized contrast difference from occurring, the gamma processing portion 31 carries out a difference limiter process so that a difference value between two offset values Voff regarding gradients 1, i+1 which are adjacently arranged is less than or equal to a predetermined value.

The gamma processing portion 31 carries out the difference limiter process using the following equation:
if (Pmin+Lim)<Pmax
then Pmax−Pmin+Lim (2)
where Pmin is the smallest offset value Voff of the offset values Voff regarding the gradients i, i+1, Pmax is the largest offset value Voff of the offset values Voff regarding the gradients i, i+1, Lim is a difference limit value which has previously defined and can be arbitrarily set.

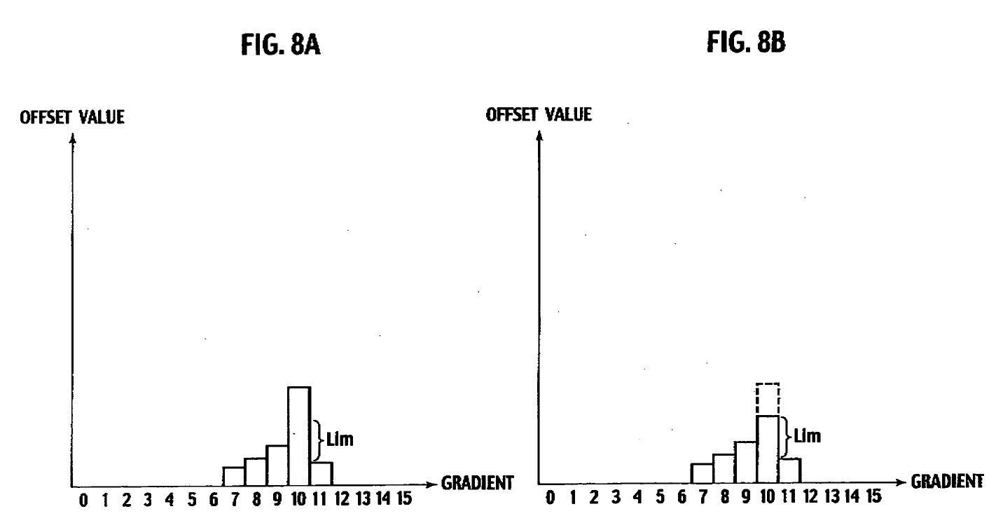

FIG. 8A is the same diagram as FIG. 7B. FIG. 8B shows an offset value distribution after the gamma processing portion 31 carries out the difference limiter process with respect to each offset value Voff shown in FIG. 8A.

In the first exemplary embodiment, the gamma processing portion 31 carries out the difference limiter process with respect to offset values Voff of the gradients 6 to 12, according to the equation (2). As a result of the difference limiter process, the offset value Voff of the gradient 10 is changed as shown in FIG. 8B. It is preferable that gradients to be processed in the difference limiter process include one or more gradients to which one or more offset values Voff are added to the first gradient correcting data corresponding and two gradients corresponding to two values generated by subtracting “1” from the smallest gradient value and adding “1” into the largest gradient value in the one or more gradients. The difference limiter process allows the difference value between the offset values Voff regarding the gradients i, i+1 to have a small value. Thereby, a smooth gradient correction can be carried out.

The gamma processing portion 31 generates the offset data on the basis of each offset value Voff generated by the difference limiter process, and then adds the offset data to the first gradient correcting data to generate the second gradient correcting data. In the first exemplary embodiment, the gamma processing portion 31 adds the offset data to the first gradient correcting data regarding the gradients 7 to 11.

When receiving the second gradient correcting data from the control unit 3, the gradient correcting portion 42 carries out the gradient correction with respect to the luminance signal component Y of the input image signal and then outputs the corrected input image signal. It is noted that the first gradient correcting data is input into the gradient correcting portion 42 at a time when the black information has a value between 0 and P1 because the attenuation value Ldec is “0”.

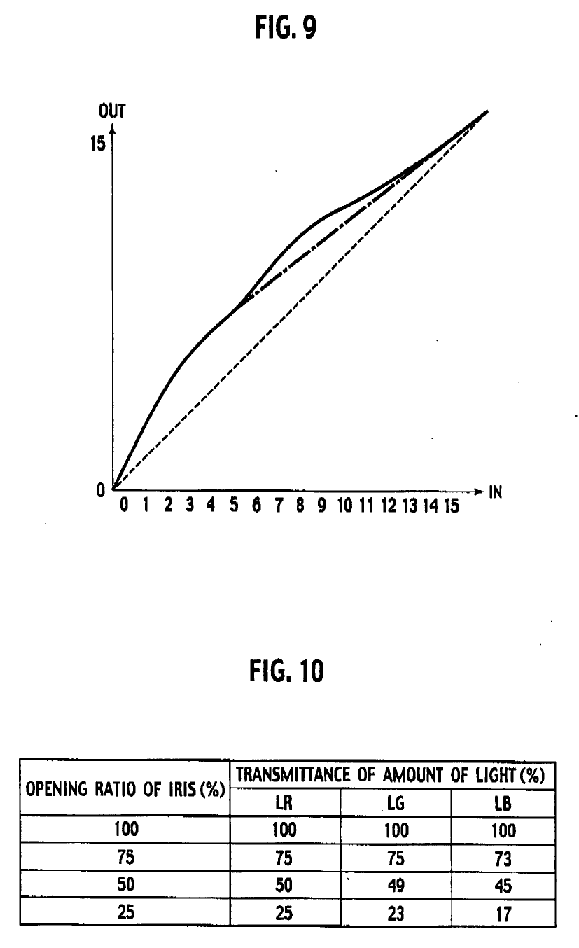

In FIG. 9, a dashed-dotted line shows a character (first gradient correcting curve) of the luminance signal component Y of the output image signal, which is corrected by using the first gradient correcting data, with respect to that of the input image signal and a solid line shows a character (second gradient correcting curve) of the luminance signal component Y of the output image signal, which is corrected by using the second gradient correcting data, with respect to that of the input image signal. It is noted that horizontal and vertical axes of FIG. 9 show the luminance signal component Y of the input image signal and that of the output image signal. As shown in the solid line in FIG. 9, the dynamic gamma process allows the gradients in the middle gradient region to increase. This holds luminance of a person's skin and a star.

Even if a ratio of the frequency of histogram data H [i] to the total frequencies of other pieces of histogram data is small due to the small number of pixels with respect to an object such as a star, luminance of the object is held because the enhancement process in the enhancement processing portion 41 and the dynamic gamma process in the gradient correcting portion 42 are linked with the adjustment of the amount of light by the iris 72.

(3. White Balance Correction Process)

The color separation portion 73 includes a first dichroic mirror, a second dichroic mirror and the plurality of reflecting mirrors. The first dichroic mirror separates light emitted from the light source 71, into light LB in a short wavelength side of the light and light LR+light LG in a long wavelength side of the light. The second dichroic mirror separates the light LR+light LG into light LG in a short wavelength side of the light LR+light LG and light LR in a long wavelength side of the light LR+light LG. The plurality of reflecting mirrors controls light paths of the light LR, the light LG and the light LB so that the light LR, the light LG and the light LB reach the light modulation elements 74R, 74G, 74B, respectively.

The amount of light having passed through the color synthesis portion 75 is adjusted in the iris 72. The adjusted light enters the projection lens 76. However, when the iris 72 is narrowed down, the balance among the light LRm, the light LGm and the light LBm emitted from the color synthesis portion 75 differs from the balance among the light LRm, the light LGm and the light LBm entering the projection lens 76. For example, if the amount of light LBm remarkably decreases, a B signal value included in an image signal value to be input into the projection lens 76 is remarkably decreased. This causes an image displayed on screen 77 to be tinged with green.

As shown in FIG. 10, variations among the transmittances of the amounts of light LR, light LG and light LB increase as the opening ratio of the iris 72 decreases. If the opening ratio of the iris 72 is less than or equal to 50%, the transmittances of the amounts of light LR and light LB have maximal and minimum values, respectively. It is noted that we consider that the transmittances of the amounts of light LR, light LG and light LB are 100% at a time when the opening ratio of the iris 72 is 100%.

In order to resolve the above-described problem, the element driving portion 78 carries out the white balance correction process. More specifically, the element driving portion 78 corrects the output image signal regarding R (red), G (green), B (blue) so that the amounts of light LRm, light LGm and light LBm which will enter the projection lens 76 have the same value one another. The white balance correction process is carried out according to the amounts of light LRm, light LGm and light LBm which will pass through the iris 72.

The element driving portion 78 is a white balance correction unit configured to receive the third control data from the control unit 3, correct the output image signal regarding R (red), G (green), B (blue) on the basis of the received third control data, and output the corrected image signals SR, SG, SB into the light modulation elements 74R, 74G, 74B, respectively.

In the first exemplary embodiment, the element driving portion 78 decreases the amounts of light LR and light LG on the basis of the amount of light LB which has a minimum value among the amounts of the light LR, the light LG and the light LB at a time when the adjustment of the amount of light by iris 72 is carried out. Accordingly, the control unit 3 outputs into the element driving portion 78 the third control data to be used to decrease an R signal value and a G signal value on the basis of the B signal value.

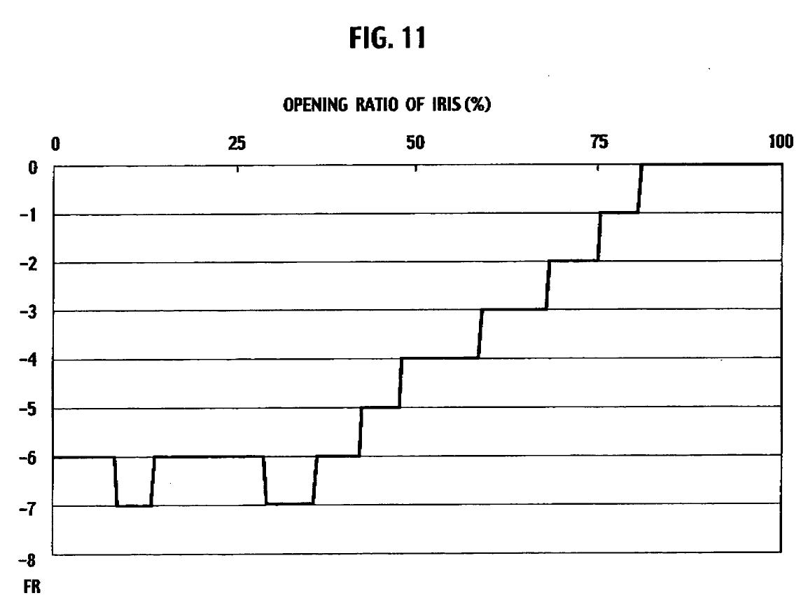

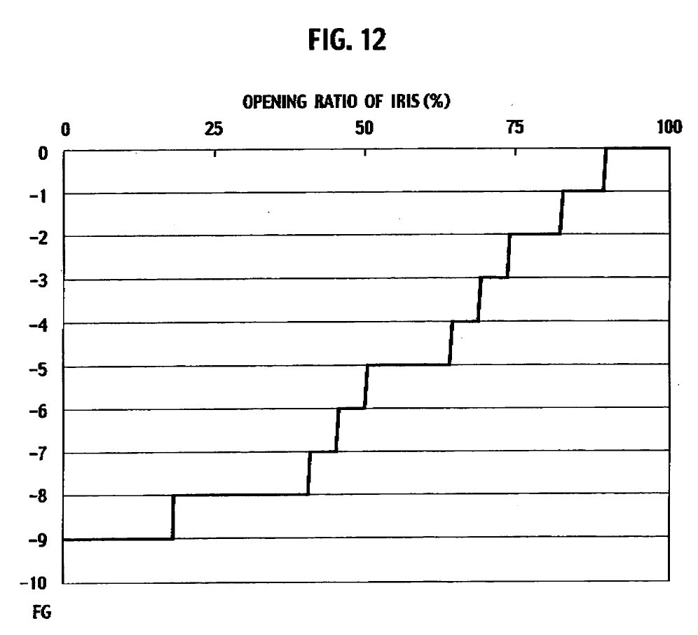

The control unit 3 refers to FIGS. 11 and 12 and calculates amount-of-light correction values regarding the R and G signals on the basis of the attenuation value Ldec. It is noted that there is not an amount-of-light correction value regarding the B signal because the control unit 3 uses the amount of light LB as the base.

Horizontal and vertical axes of FIG. 11 show the opening ratio of the iris 72 (0% shows a fully close condition of the iris 72 and 100% shows a fully open condition of the iris 72) and the amount-of-light correction value FR regarding the R signal, respectively. It is noted that the opening ratio of the iris 72 is 100% at a time when the attenuation value Ldec is 0% and the opening ratio of the iris 72 is 0% at a time when the attenuation value Ldec is 100%.

Also, horizontal and vertical axes of FIG. 12 show the opening ratio of the iris 72 (0% shows a fully close condition of the iris 72 and 100% shows a fully open condition of the iris 72) and the amount-of-light correction value FG regarding the G signal, respectively. The amount-of-light correction values FR, FG are varied according to the amount of light which will pass through the iris 72.

The third control data including the amount-of-light correction values PR, FG regarding the R and G signals is output from the control unit 3 into the element driving portion 78. The control unit 3 is a white balance control unit configured to control the correction of a white balance according to the amount of light which will pass through the iris 72.

The element driving portion 78 generates the corrected image signals SR, SG, SB on the basis the third control data. More specifically, the corrected image signal SR is generated by offsetting the am amount-of-light correction value FR into the R signal which is input into the element driving portion 78. The corrected image signal SG is generated by offsetting the amount-of-light correction value FG into the G signal which is input into the element driving portion 78. The corrected image signal SB is the same signal as the B signal which is input into the element driving portion 78. The control unit 3 prevents the amount-of-light correction value from varying discontinuously in the time based process as will be described later.

The corrected image signals SR, SG, SB are input into the light modulation elements 74R, 74G. 74 8, respectively. The light modulation elements 74R, 74G, 74B modulates the light LR, the light LG and the light LB into the light LRm, the light LGm and the light LBm on the basis of the corrected image signals SR, SG, SB, respectively. Then, the light modulation elements 74R, 74G, 74B output the light LRm, the light LGm and the light LBm into the color synthesis portion 75.

(4. Time Based Process)

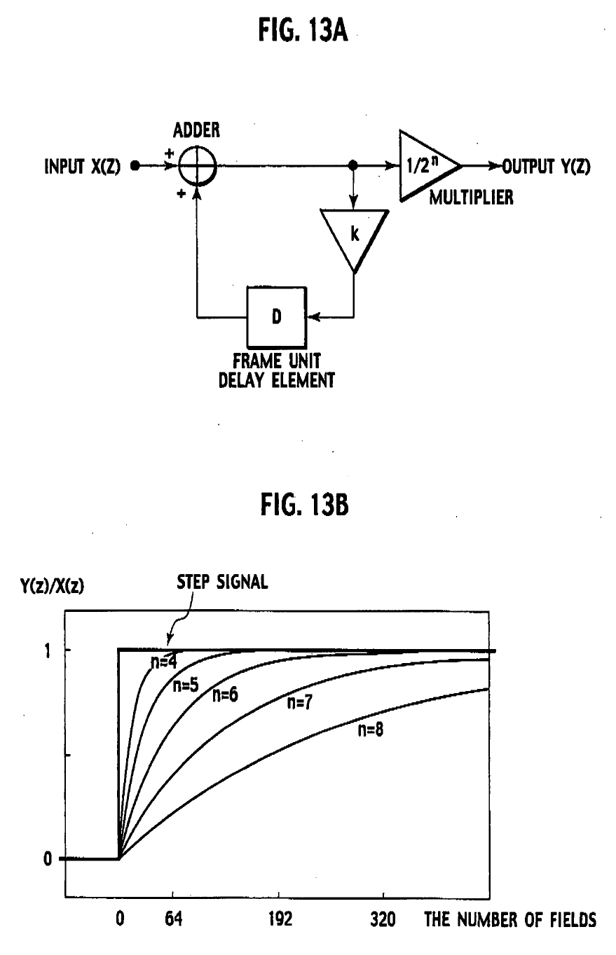

The time based process is a process for controlling a variation rate of the amount of light so that a person's eye does not perceive a discontinuous brightness variation, in a case where the iris 72 is dynamically controlled by one field or one frame. When the iris control data (second control data) is updated, the time based process is carried out by using a lowpass filter (LPF) as shown in FIG. 13 so that the variation rate of the amount of light by one frame does not have a value which is more than or equal to a predetermined value. The time based process is further carried out so that a variation rate of the luminance signal component Y of the input image signal and/or a variation rate of the edge of an image have/has the same time constant as one of the variation rate of the amount of light.

The control unit 3 is provided with an IIR filter configured to carry out a filter process along a time axis direction. As shown in FIG. 13A, the IIR filter has an adder, a multiplier and a frame unit delay element. The IIR filter prevents processes carried out in the enhancement processing portion 41, the gradient correcting portion 42, the element driving portion 78 and the iris driving portion 79 from generating discontinuous variations. An equation regarding a transfer characteristic of the IIR filter is as follows:
Y(z)/X(z)=1/(1−k*z−1), k=1−1/2ⁿ (3)
where k is a feedback coefficient (leak coefficient) (k<1).

Horizontal and vertical axes of FIG. 13B show the number of fields and the transfer characteristics for parameters n=4, 5, 6, 7, 8, respectively. The IIR filter can easily adjust a response speed of the iris control data by using the parameter n which leads the feedback coefficient K. A value of the parameter n can be arbitrarily set. In the first exemplary embodiment, the value of the parameter n is 2 or 3 (not shown in FIG. 13B).

By carrying out the above-described series of processes (the enhancement process, the dynamic gamma process, the white balance correction process and the time based process), the image display device 10 can adaptively control the iris 72 according to the brightness of the input image signal. This allows the image display device 10 to reproduce a substantially real black color of an image to be displayed on the screen 77 to give a contrasty image to a user, while the displayed image keeps the brightness in a white side.

### Second Exemplary Embodiment

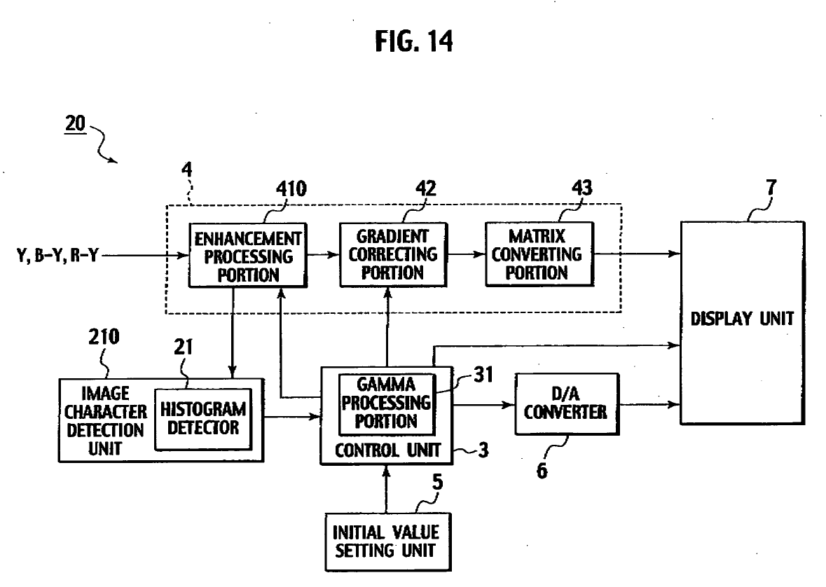

An image display device 20 according to a second exemplary embodiment of the present invention will be described below in detail, with reference to FIG. 14. In FIG. 14, the same elements as those of the image display device 10 are given the same reference numerals. In the second exemplary embodiment, a description of the same elements as those of the image display device 10 is omitted.

The image character detection unit 2 generates the detection signal on the basis of the input image signal which is input into the image character detection unit 2. On the other hand, an image character detection unit 210 generates a detection signal on the basis of an image signal generated by adding a chute component into the input image signal in the enhancement process carried out by an enhancement processing portion 410. The image character detection unit 210 generates the detection signal by using the same method as that used in the image character detection unit 2.

The control unit 3 receives the detection signal from the image character detection unit 210 and generates the enhancement data (first control data), the attenuation value Ldec, the iris control data (second control data), the offset data (additional data) and the amount-of-light correction data (third control data). The enhancement processing portion 410 receives from the control unit 3 the enhancement data in which the horizontal gain GH and the vertical gain GV (a degree of edge reinforcement) increase as the ratio of the total frequencies of 2 pieces of histogram data H(0) and H(1) to the total frequencies of all 16 pieces of histogram data increases by a predetermined time, and carries out the enhancement process.

### Third Exemplary Embodiment

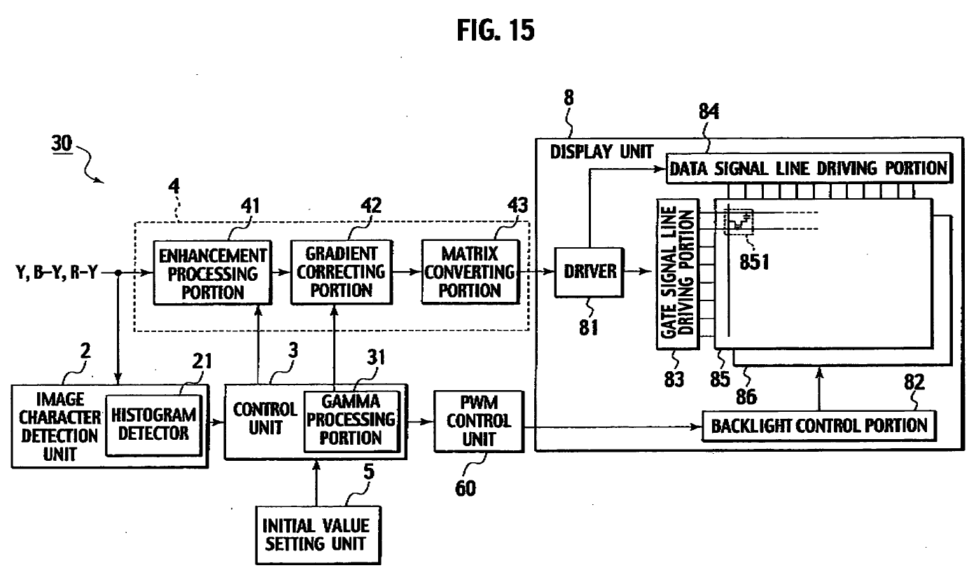

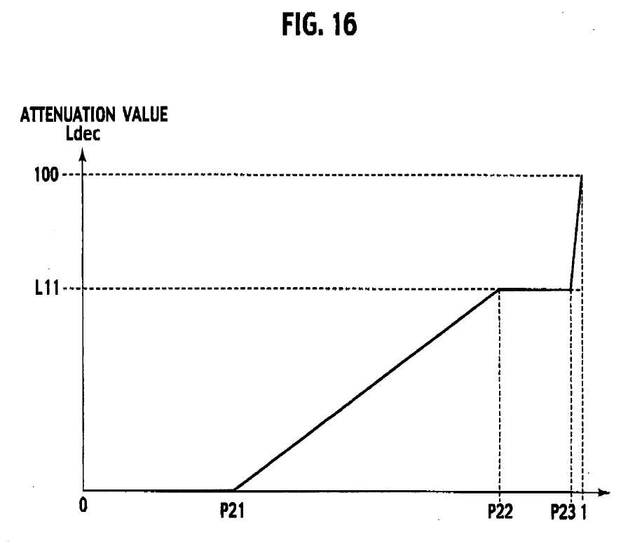

An image display device 30 according to a third exemplary embodiment of the present invention will be described below in detail, with reference to FIGS. 15 and 16. In FIG. 15, the same elements as those of the image display device 10 are given the same reference numerals. In the third exemplary embodiment, a description of the same elements as those of the image display device 10 is omitted.

The image display device 30 comprises the image character detection unit 2, the control unit 3, the image signal processing unit 4, the initial value setting unit 5, a PWM control unit 60 and a display unit 8. The display unit 8 has a driver 81, a backlight control portion 82, a gate signal line driving portion 83, a data signal line driving portion 84, a liquid crystal panel 85 and a backlight 86.

The output image signal output from the image signal processing unit 4 is input into the driver 81. The liquid crystal panel 85 includes a plurality of pixels 851. The gate signal line driving portion 83 is connected to a gate signal line of each pixel 851 and the data signal line driving portion 84 is connected to a data signal line of each pixels 851. The output image signal input into the driver 81 is input into the data signal line driving portion 83. The driver 81 control a timing of writing the output image signal to the liquid crystal panel 85 by using the gate signal line driving portion 83 and the data signal line driving portion 84.

The backlight 86 is mounted on a back face of the liquid crystal panel 85. The backlight 86 is driven by the backlight control portion 82. The backlight control portion 82 receives from the PWM control unit 60 drive pulses to be used to light the backlight 86. For example, the backlight 86 is composed of a plurality of red, green and blue light emitting diodes (LEDs). In the third exemplary embodiment, the backlight 86 is composed of the LEDs to be driven by the drive pulses modulated by a pulse-width modulation. However, the LEDs may be driven by current values to be adjusted to control the luminance of LEDs, instead of the drive pulses. It is noted that the backlight 86 is not limited to the LEDs.

A horizontal synchronization signal and a vertical synchronization signal separated from the input image signal are input into the driver 81 and the backlight control portion 82, thereby the brightness of the backlight 86 is adjusted in response to an image display by one frame in the liquid crystal panel 85.

The control unit 3 refers to FIG. 16 to generate amount-of-light control data on the basis of the detection signal output from the image character detection unit 2, and output the amount-of-light control data into the PWM control unit 60. The control unit 3 also generates the enhancement data and offset data on the basis of the detection signal.

Horizontal and vertical axes of FIG. 16 show a ratio (black information) of a total frequencies of 2 pieces of histogram data H(0) and H(1) to a total frequencies of all 16 pieces of histogram data and an attenuation value Ldec of the backlight 86, respectively. When the attenuation value Ldec is 100%, the backlight 86 is turned off.

The control unit 3 receives the initial setting value from the initial value setting unit 5 and then generates the amount-of-light control data on the basis of the initial setting value and the attenuation value Ldec. The initial setting value is a current value which allows the brightness of the backlight 86 to be the largest.

The PWM control unit 60 receives the amount-of-light control data from the control unit 3 and then generates the drive pulses regarding R (red), G (green) and B (blue). The backlight control portion 82 is an amount-of-light adjustment unit configured to adjust an amount of light to be emitted from the backlight 86 on the basis of the generated drive pulses.

### Fourth Exemplary Embodiment

In the fourth exemplary embodiment, the image character detection unit 2 and the enhancement processing portion 41 of the image display device 30 in the third exemplary embodiment is replaced by the image character detection unit 210 and the enhancement processing unit 410 of the image display device 20 in the second exemplary embodiment. In this case, the input image signal is input into the image character detection unit 210 after inputted into the enhancement processing portion 410.

According to the image display devices of the first to fourth exemplary embodiments, each image display device carries out an amount-of-light control according to an input image signal and an image signal process linked with the amount-of-light control. This allows each image display device to reproduce a substantially real black color of an image to be displayed to give a contrasty image to a user, while the displayed image keeps the brightness in a white side.

What is claimed is:

1. An image display device comprising:
a display unit configured to display an image signal thereon;
a light source configured to emit light to be used to display the image signal on the display unit;
an amount-of-light adjustment unit configured to adjust an amount of light emitted from the light source;
a histogram generating unit configured to normalize each luminance value of a luminance signal component of the image signal in the range of a minimum luminance value to a maximum luminance value of the luminance signal component by a predetermined time to generate plural gradients of the luminance signal component and generate histogram data which shows a distribution of frequencies of the plural gradients;
a holding unit configured to hold first gradient correction data which is used to decide a character of an output gradient with respect to an input gradient of the image signal;
an amount-of-light control unit configured to control the amount-of-light adjustment unit on the basis of the histogram data so that the amount of light emitted from the light source decreases as a ratio of total frequencies of one or more gradients corresponding to a black color to total frequencies of the plural gradients increases by the predetermined time;
an additional data generating unit configured to generate additional data including one or more values which each increases as the ratio of the total frequencies of the one or more gradients corresponding to the black color to the total frequencies of the plural gradients increases by the predetermined time, wherein the additional data is used to add the one or more values into the first gradient correction data in order to increase one or more gradients in a middle gradient region of the image signal; and
a gradient correction unit configured to correct one or more gradients of the image signal on the basis of either one of the first gradient correction data and second gradient correction data generated by adding the additional data into the first gradient correction data.

2. The image display device according to claim 1, further comprising:
an enhancement processing unit configured to carry out an edge reinforcement of the image signal; and
a control unit configured to control the enhancement processing unit on the basis of the histogram data so that the edge reinforcement is promoted as the ratio of the total frequencies of the one or more gradients corresponding to the black color to the total frequencies of the plural gradients increases by the predetermined time.

3. The image display device according to claim 2, wherein the enhancement processing unit inputs the image signal of which the edge reinforcement has been carried out into the gradient correction unit and the histogram generating unit.

4. The image display device according to claim 1, wherein the additional data generating unit generates the additional data so that a difference between adjacent gradients in a gradient region including the middle gradient region is equal to or less than a predetermined value.

5. The image display device according to claim 1, wherein further comprising:
a light modulation element configured to modulate light entering the light modulation element on the basis of the image signal;
a white balance correction unit configured to correct a white balance of the image signal and input the corrected image signal into the light modulation element; and
a white balance control unit configured to control a correction of the white balance in the white balance correction unit according to the amount of light passing through the amount-of-light adjustment unit,
wherein the light source emits the light which is to enter the light modulation element and
the amount-of-light adjustment unit is an iris configured to adjust the amount of light emitted from the light source.

6. The image display device according to claim 1, wherein
the display unit has a liquid crystal panel and
the light source is a backlight configured to emit light which is to enter the liquid crystal panel.

7. An image display method comprising the steps of:
normalizing each luminance value of a luminance signal component of an image signal to be displayed on a display unit in the range of plural gradients by a predetermined time and generating histogram data which shows a distribution of frequencies of the plural gradients;
calculating a ratio of total frequencies of one or more gradients corresponding to a black color to total frequencies of the plural gradients by the predetermined time on the basis of the histogram data;
decreasing an amount of light to be emitted from a light source and used to display the image signal on the display unit as the ratio of the total frequencies of the one or more gradients corresponding to the black color to the total frequencies of the plural gradients increases; and
increasing one or more gradients in a middle gradient region of the image signal as the amount of light emitted from the light source decreases.

8. The image display method according to claim 7, further comprising a step of promoting an edge reinforcement of the image signal as the amount of light emitted from the light source decreases.
